(19) United States
(12) Patent Application Publication
(10) Pub. No.: US 2012/0001868 A1
(43) Pub. Date: Jan. 5, 2012

(54) COMPOSITE TOUCH SCREEN PANEL

(75) Inventors: In-Hak Na, Suwon-si (KR); In-Kwon Kang, Seoul (KR); Kwan-Sic Kim, Hwaseong-si (KR); Ji-Eun Shin, Suwon-si (KR)

(73) Assignee: Samsung Electronics Co., Ltd., Suwon-si (KR)

(21) Appl. No.: 13/174,425

(22) Filed: Jun. 30, 2011

(30) Foreign Application Priority Data
Jun. 30, 2010 (KR) 10-2010-0062676

(51) Int. Cl. G06F 3/045; G06F 3/041

(52) U.S. Cl. 345/174; 345/173

(57) ABSTRACT

A composite touch screen panel applied to an electronic device concurrently supports a spatial touch device and a surface touch panel. The panel includes a display module, the surface touch panel, the spatial touch device, and a controller. The display module outputs data. The surface touch panel is disposed on the display module and detects when a touch on a surface of the touch screen panel. The spatial touch device is interposed in constituent elements of the surface touch panel. And a controller senses a touch position detected in the spatial touch device and the surface touch panel, and performs a corresponding function of the electronic device.

### CROSS-REFERENCE TO RELATED APPLICATION(S) AND CLAIM OF PRIORITY

The present application is related to and claims the benefit under 35 U.S.C. §119(a) of a Korean patent application filed in the Korean Intellectual Property Office on “Jun. 30, 2010” and assigned Serial No. “10-2010-0062676”, the entire disclosure of which is hereby incorporated by reference.

### FIELD OF THE INVENTION

The present invention relates to a composite touch screen panel used as a data input/output means of an electronic device. More particularly, the present invention relates to a composite touch screen panel constructed to increase the efficiency of mounting space by using an existing surface touch panel structure as while adding a 3-Dimensional (3D) spatial touch scheme.

### BACKGROUND OF THE INVENTION

In general, various kinds of electronic devices include input units for data input and output units for data output. The input unit may be broadly classified into a key button unit and such, and the output unit may be broadly classified into a display unit including a display module.

In recent years, touch screen panels capable of performing data input and output in the same position and remarkably reducing the volumes of electronic devices while diversifying functions thereof have been put in the market. In the touch screen panel, a transparent touch panel is disposed on a display module, whereby input and output are achieved concurrently. The transparent touch panel is divided into touch panels of various schemes such as resistive touch panels, capacitive touch panels, ultrasonic touch panels, light (infrared ray) sensing touch panels, electro-magnetic induction touch panels, Acoustic Pulse Recognition (APR) panels and such.

Among these touch panels, when the resistive or capacitive touch panel is applied in a surface touch scheme, it causes a disadvantage in that the resistive or capacitive touch panel alone is not used as 3D spatial touch.

The light (infrared ray) touch panel recognizes a corresponding coordinate and performs a touch operation, by disposing a plurality of light sources (e.g., InfraRed (IR) Light Emitting Diodes (LEDs)) outside a display module at constant intervals, irradiating light into a specific space, and allowing a photo sensor to receive IR rays reflected from an object (e.g., a finger and the like) in space.

This spatial touch panel has an advantage in that a touch screen surface is not contaminated by foreign materials and is not damaged because it is not directly touching the touch screen surface. However its disadvantages include high power consumption and not allowing accurate and precise touch operation like a surface touch panel. For instance, the spatial touch panel has a disadvantage in that 16 milli-amperes (mA) are consumed per IR, and the spatial touch panel should include light emitting and light receiving units of 30 milli watts (mW) minimum. Furthermore, because the spatial touch panel should provide a separate mounting space for a plurality of light emitting units and light receiving units, the spatial touch panel results in a problem that it is retrogressive against the slimming of a terminal.

The APR panel is installed at a fringe portion of a glass substrate to face a plurality of input piezoelectric materials and reception piezoelectric materials, allowing the reception piezoelectric material to receive a surface acoustic wave emitted from the input piezoelectric material such that the APR panel senses a touch according to the attenuation or non-attenuation of the surface acoustic wave. But, this APR scheme cannot be aware of a finger touch maintenance time, causing a problem such that a long key function or drag function is impossible.

Accordingly, researches on various methods for compensating the disadvantages of the aforementioned touch panels are being conducted.

### SUMMARY OF THE INVENTION

To address the above-discussed deficiencies of the prior art, it is a primary object to provide at least the advantages below. Accordingly, one aspect of the present invention is to provide a composite touch screen panel realized to compensate the aforementioned disadvantages using an existing surface touch panel and a supplementary spatial touch panel.

Another aspect of the present invention is to provide a composite touch screen panel configured to reduce a mounting space to the maximum to make a contribution to the slimming of a terminal while making use of a spatial touch scheme and a surface touch scheme simultaneously.

A further aspect of the present invention is to provide a composite touch screen panel configured to use spatial touch and surface touch together with the minimum power consumption.

Yet another aspect of the present invention is to provide a composite touch screen panel realized to reduce a manufacturing cost.

The above aspects are achieved by providing a composite touch screen panel.

According to one aspect of the present invention, a composite touch screen panel applied to an electronic device is provided. The composite touch screen panel includes a display module, a surface touch panel, a spatial touch device, and a controller. The display module outputs data. The surface touch panel is disposed on the display module. The spatial touch device is interposed in constituent elements of the surface touch panel. And the controller senses a touch position detected in the spatial touch device and the surface touch panel and performs a corresponding function of the electronic device.

According to another aspect of the present invention, a portable terminal is provided. The portable terminal includes a composite touch screen panel that concurrently supports a spatial touch device and a surface touch panel. The composite touch screen panel includes a display module, the surface touch panel, the spatial touch device, and a controller. The display module outputs data. The surface touch panel is disposed on the display module and detects when a touch on a surface of the touch screen panel. The spatial touch device is interposed in constituent elements of the surface touch panel. And a controller senses a touch position detected in the spatial touch device and the surface touch panel, and performs a corresponding function of the electronic device.

The spatial touch device includes an electrode transmitter formed in the conductive layer of the ITO film layer, and at least one electric field sensor formed or installed in a layer other than the ITO film layer and reading out an electric field value transmitted in the electrode transmitter.

Other aspects, advantages, and salient features of the invention will become apparent to those skilled in the art from the following detailed description, which, taken in conjunction with the annexed drawings, discloses embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a portable terminal applying a composite touch screen panel according to an embodiment of the present invention;

FIG. 2 illustrates a composite touch screen panel according to an embodiment of the present invention;

FIG. 3 illustrates an electric field sensor according to an embodiment of the present invention; and

FIG. 4 illustrates a composite touch screen panel according to an embodiment of the present invention.

Throughout the drawings, it should be noted that like reference numbers are used to depict the same or similar elements, features, and structures.

### DETAILED DESCRIPTION OF THE INVENTION

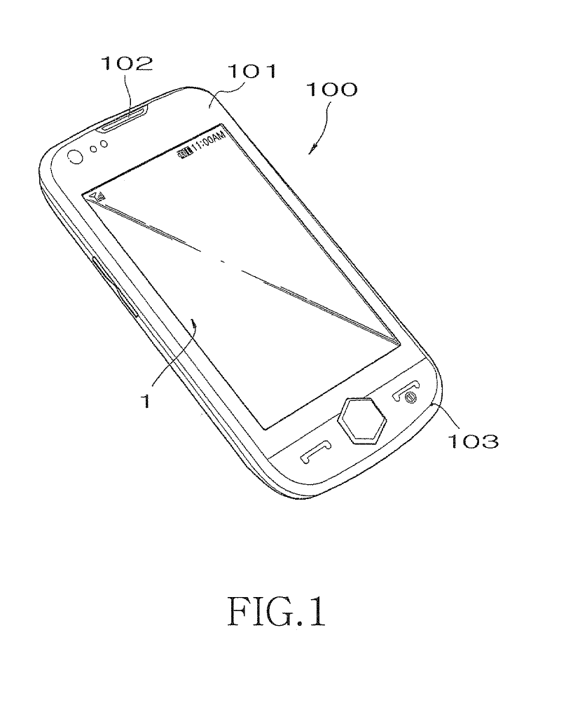

FIGS. 1 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged portable terminal. The following description with reference to the accompanying drawings is provided to assist in a comprehensive understanding of embodiments of the invention as defined by the claims and their equivalents. It includes various specific details to assist in that understanding but these are to be regarded as merely example embodiments. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of embodiments of the present invention are provided for illustrative purposes only and do not limit the scope of the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “substantially” denotes that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

The drawings illustrate a portable terminal and illustrate and describe a composite touch screen panel applied to a portable terminal, but this is not intended to limit the scope of the present invention. For example, a composite touch screen panel according to an embodiment of the present invention will be applicable to various electronic devices capable of supporting a touch screen device for data input/output.

FIG. 1 is a perspective diagram illustrating a portable terminal 100 in which a composite touch screen panel 1 is applied according to an embodiment of the present invention. The composite touch screen panel 1 is installed in front of the terminal 100 within a predetermined case frame 101. The composite touch screen panel 1 supports data input and output functions simultaneously. A speaker unit 102 is installed above the composite touch screen panel 1, and a microphone unit 103 is installed below the composite touch screen panel 1.

According to the present invention, even when a user's finger does not get in direct contact with a surface of a touch screen, the composite touch screen panel 1 detects the user's finger. This is due to a spatial touch panel (i.e., an electric field sensor) to be described. However, even when the user makes his/her finger contact with the touch screen surface and makes the composite touch screen panel 1 work, a surface touch operation is performed. This is due to an existing surface touch panel (for example, a resistive touch panel, a capacitive touch panel and the like) mounted together with the spatial touch panel. That is, it is possible to perform various touch operations according to user's preference. For instance, in a situation where a relatively precise touch operation is needed, the user may make his/her finger directly contact with the touch screen surface, operate only the surface touch panel, and perform a touch operation. In a situation where the user desires a long key function or a drag function, he/she may isolate the finger from the touch screen surface and perform a touch operation using the spatial touch panel.

According to an embodiment the spatial touch panel and the surface touch panel work mutually exclusively. That is, when the spatial touch panel works, the surface touch panel may not work and, when the surface touch panel works, the spatial touch panel must not work. However, this does not intend to limit the scope of the present invention. For example, when the spatial touch panel works, it does not matter that the surface touch panel works.

The composite touch screen panel 1 is described below in detail.

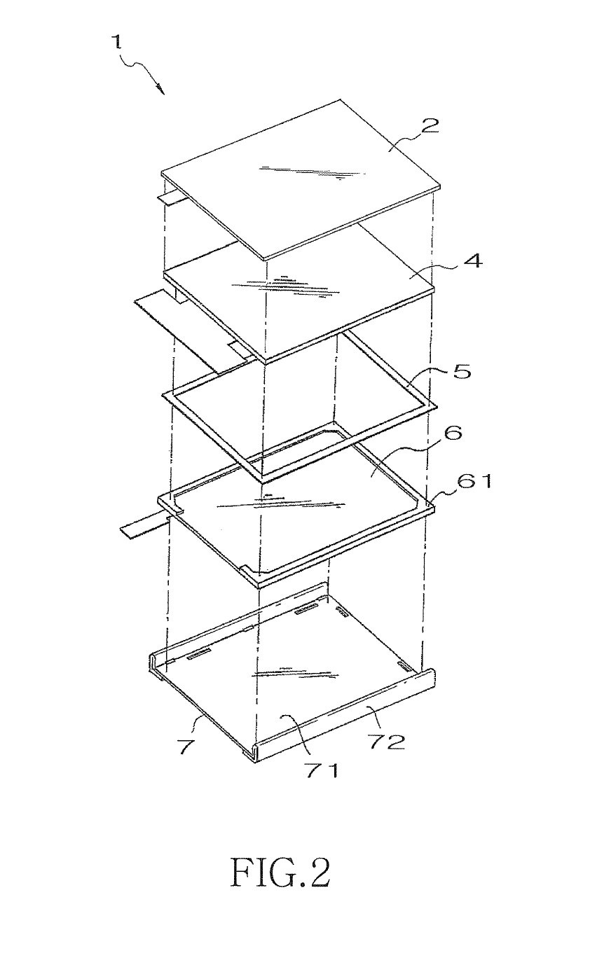

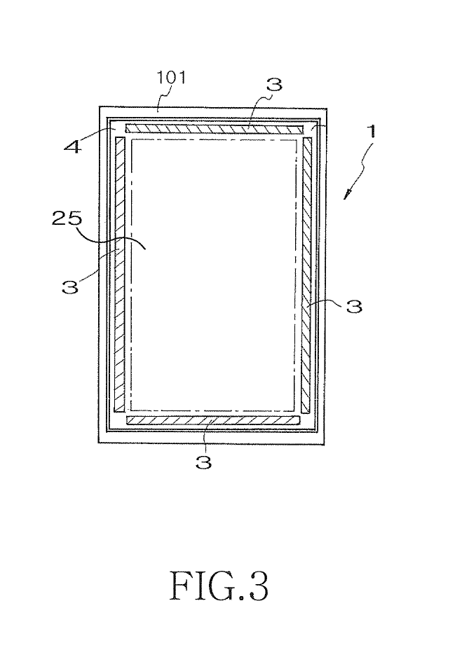

FIG. 2 is an exploded perspective diagram illustrating a composite touch screen panel according to an embodiment of the present invention. FIG. 3 is a diagram illustrating an array of an electric field sensor according to an embodiment of the present invention.

The composite touch screen panel 1 coexists together within a surface touch panel 2 disposed on a display module 4. A space for a separate spatial touch panel is excluded, thus making a contribution to the slimming of a terminal. According to an embodiment, the display module 4 can be a Liquid Crystal Display (LCD) module.

A reinforcement plate 7 for accepting and realizing the surface touch panel 2 and the display module 4 as a combined assembly and a backlight unit 6 are further installed.

The reinforcement plate 7 has a plane portion 71 for accepting the backlight unit 6, and a side portion 72 upwardly bent at a constant height along an edge of the plane part 71, This is to protect the accepted constituent elements from external impacts. According to an embodiment, the reinforcement plate 7 may be realized by Stainless Steel (SUS) materials or synthetic resin materials.

The backlight unit 6 laminated on the reinforcement plate 7 is surrounded along its edge by a frame 61 of synthetic resin materials and facilitates its lamination on the plane part 71 of the reinforcement plate 7.

The display module 4 may be a High-Definition (HD) color Thin Film Transistor (TFT) display module. The display module 4 may be attached to a top surface of the backlight unit 6 by means of a double coated tape 5.

The surface touch panel 2 is laminated on the display module 4. A spatial touch device according to the present invention is installed within a constituent element of the surface touch panel 2.

The spatial touch device includes an electrode transmitter and an electric field sensor. The electrode transmitter is formed in an Indium Tin Oxide (ITO) film layer of the surface touch panel 2 to be described later. The electric field sensor is interposed in a suitable position among the constituent elements of the surface touch panel 2.

The electrode transmitter may be designed to avoid a silver (Ag) (or Argentum) line of the ITO film layer (i.e., transparent film), and can be formed along an edge of the ITO film layer. Accordingly, if a power source is applied, an electric field of a substantially constant value may be continuously generated by the electrode transmitter.

As illustrated in FIG. 3, the electric field sensor 3 can be installed at an edge of the LCD module 4 of the case frame 101. But, this does not intend to limit the scope of the present invention, as the electric field sensor 3 may be installed or formed along an inactive area of the edge, not an active area 25 of the LCD module 4. According to an embodiment, the electric field sensor 3 is installed along a side of each edge of the LCD module 4. For example, a controller of a terminal can allow each electric field sensor 3 to continuously receive a constant electric field value generated in the electrode transmitter, and may read out a change of the electric field value by dielectric materials detected on a panel surface and detect this position.

Also, in an embodiment, when the electric field sensor 3 operates, the terminal controller may stop an operation of the surface touch panel 2, and when surface touch is performed, the terminal controller may stop an operation of the electric field sensor 3.

According to an embodiment, the surface touch panel 2 can have a construction of a resistive or capacitive touch panel.

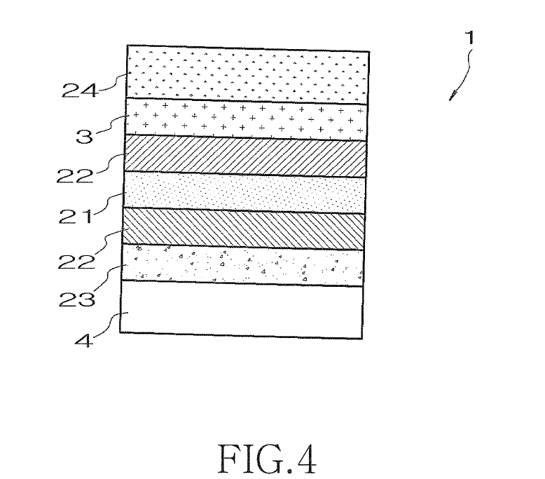

FIG. 4 is a cross sectional view of a main part of a composite touch screen panel according to an embodiment of the present invention. The touch screen panel includes a window glass 24 and a PolyEthylene Terephthalate (PET) layer 23, which are each laminated and attached above and below the ITO film layer 21, respectively, by Optical Clear Adhesive (OCA) layers 22. Additionally, the touch screen panel includes the aforementioned electric field sensor 3 interposed in a suitable position among the constituent elements. Non-shown air gap layer and double coated tape layer may be further added to a bottom of the PET layer 23.

Alternatively, an electrode transmitter according to an embodiment of the present invention can be formed in a conductive layer (not shown) of the ITO film layer 21. In this situation, it is desirable that the electrode transmitter is formed avoiding an Ag line. Accordingly, it is desirable to configure such a circuit construction such that, when a power source is applied, an Ag line for surface touch and an electrode transmission line for space touch work separately. Also, in a situation where the ITO film layer film 21 is separated into upper and lower ITO film layers, the electrode transmitter may be formed in the upper ITO film layer according to an embodiment. But, this does not intend to limit the scope of the present invention, and the electrode transmitter may be formed in the lower ITO film layer.

Also, it does not matter that the electric field sensor 3 is installed in any position among constituent elements of the surface touch panel 2. For example, as illustrated, the electric field sensor 3 is disposed on the ITO film layer 21, i.e., under the window glass 24, but this does not intend to limit the scope of the present invention. For instance, it may not matter that the electric field sensor 3 is disposed just below the ITO film layer 21, and it may not matter that the electric field sensor 3 is disposed below the PET layer 23. That is, it is possible to dispose the electric field sensor 3 in various positions depending on a shape of a terminal applied and a design of a mounting space.

Thus, by using a combination of an existing surface touch panel and a spatial touch scheme in constituent elements of the surface touch panel, embodiments of the present invention have an effect of being capable of, although using composite touch, not only reducing a mounting space remarkably and making a contribution to the slimming of a terminal, but also promoting reduction of power consumption caused by an electric field sensor and saving manufacturing cost at installation.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A composite touch screen panel applied to an electronic device, the composite touch screen panel comprising:
a display module configured to output data;
a surface touch panel disposed on the display module;
a spatial touch device interposed in constituent elements of the surface touch panel; and
a controller configured to sense a touch position detected in the spatial touch device and the surface touch panel and perform a corresponding function of the electronic device.

2. The composite touch screen panel of claim 1, wherein the surface touch panel comprises an Indium Tin Oxide (ITO) film layer whose conductive layer is used as an Silver (Ag) line.

3. The composite touch screen panel of claim 2, wherein the spatial touch device comprises:
an electrode transmitter formed in the conductive layer of the ITO film layer; and
at least one electric field sensor formed or installed in a layer other than the ITO film layer and configured to read out an electric field value transmitted in the electrode transmitter.

4. The composite touch screen panel of claim 3, wherein the electrode transmitter is formed along an edge of the ITO film layer, and is disposed to avoid the Ag line.

5. The composite touch screen panel of claim 4, wherein the electric field sensor is installed above the ITO film layer.

6. The composite touch screen panel of claim 4, wherein the electric field sensor is installed below the ITO film layer

7. The composite touch screen panel of claim 4, wherein the electric field sensor is disposed along each side edge of the display module, the electric field sensor disposed to avoid an active area of the display module.

8. The composite touch screen panel of claim 1, wherein the controller is configured to operate the spatial touch device and the surface touch panel mutually exclusively.

9. The composite touch screen panel of claim 8, wherein, when the surface touch panel is in operation, the controller is configured to not operate the spatial touch device.

10. The composite touch screen panel of claim 1, wherein the surface touch panel comprises one of a resistive touch panel and a capacitive touch panel.

11. A portable terminal, comprising:
a composite touch screen panel configured to concurrently support a spatial touch device and a surface touch panel, the composite touch screen panel comprising:
a display module configured to output data;
the surface touch panel disposed on the display module;
the spatial touch device interposed in constituent elements of the surface touch panel, and
a controller configured to sense a touch position detected in the spatial touch device and the surface touch panel and perform a corresponding function of the electronic device.

12. The portable terminal of claim 11, wherein the surface touch panel comprises an Indium Tin Oxide (ITO) film layer whose conductive layer is used as an Silver (Ag) line.

13. The portable terminal of claim 12, wherein the spatial touch device comprises:
an electrode transmitter formed in the conductive layer of the ITO film layer; and
at least one electric field sensor formed or installed in a layer other than the ITO film layer and configured to read out an electric field value transmitted in the electrode transmitter.

14. The portable terminal of claim 13, wherein the electrode transmitter is formed along an edge of the ITO film layer, and is disposed to avoid the Ag line.

15. The portable terminal of claim 14, wherein the electric field sensor is installed above the ITO film layer.

16. The portable terminal of claim 14, wherein the electric field sensor is installed above the ITO film layer.

17. The portable terminal of claim 14, wherein the electric field sensor is disposed along each side edge of the display module, the electric field sensor disposed to avoid an active area of the display module.

18. The portable terminal of claim 11, wherein the controller is configured to operate the spatial touch device and the surface touch panel mutually exclusively.

19. The portable terminal of claim 18, wherein, when the surface touch panel is in operation, the controller is configured to not operate the spatial touch device.

20. The portable terminal of claim 11, wherein the surface touch panel comprises one of a resistive touch panel and a capacitive touch panel.
